(19) United States
(12) Patent Application Publication
(10) Pub. No.: US 2025/0287865 A1
(43) Pub. Date: Sep. 18, 2025

(54) METERING UNIT FOR A SEED DRILL AND ASSOCIATED DRAIN METHOD

(71) Applicant: KUHN SAS, Saverne (FR)

(72) Inventor: Olivier CONSTANT, Weiterswiller (FR)

(73) Assignee: KUHN SAS, Saverne (FR)

(21) Appl. No.: 19/068,039

(22) Filed: Mar. 3, 2025

(30) Foreign Application Priority Data
Mar. 15, 2024 (FR) FR2402626

(51) Int. Cl. A01C 7/20; A01C 7/04

(52) U.S. Cl. CPC A01C 7/20; A01C 7/046

(57) ABSTRACT

A metering unit for a seed drill comprising a casing comprising a fixed part and a door, a metering element for a plurality of granular elements, arranged for discrete and singular distribution of a plurality of granular elements, a drain chute mounted on the outside of the fixed part of the casing, wherein the drain chute is configured so that it can be positioned in an intermediate drain position, in which the drain chute is configured to allow the flow of all or part of the plurality of granular elements initially present in the reserve zone towards a buffer zone of the drain chute and to allow the storage of said granular elements in the buffer zone without them flowing directly out of the drain chute, the buffer zone having a buffer height less than the reserve height.

### BACKGROUND OF THE INVENTION

### Field of the Invention

The present invention relates to the field of metering units for a seed drill and to the field of drain methods.

The invention therefore relates more generally to the field of single seeding, also known as precision seeding, in other words seeding in rows of seeds, one by one. Single seeding is used for maize, beet, soy or similar crops.

A single-grain seed drill generally takes the form of a beam-chassis on which seeder elements are fixed, most often between 4 and 12, or even more, by means of a parallelogram. The spacing between these seeder elements varies according to the crop, preferably between 37.5 centimeters and 80 centimeters, but allows the formation of distinct rows. For this reason, it is common in this case to refer to row crops, as opposed to crops such as wheat where the spacing is much more compact.

In a known manner, a metering unit for a single-grain seed drill operates on the whole in the manner set out below.

A two-part airtight casing has a drilled metering disc driven in rotation, preferably by a motor that forms a metering element for a plurality of granular elements. The metering disc separates the casing into two chambers with different air pressures, thereby creating a pressure difference which may be positive or negative on either side of the drilled metering disc. The casing is connected to a blower that makes it possible to manage the pressure difference according to the type of seed, speed of advance, and other parameters.

Under the drilled metering disc, in other words at the bottom of the casing, there is a reserve zone for granular elements, for example seeds, usually supplied by a hopper. These seeds are in contact with the rotating drilled metering disc which, as it rotates, will drag the seeds one by one into its drilling holes.

The diameter and shape of the drilling holes of the metering disc are made so as to be able to accommodate a single granular element, for example a seed, with the granular element held in the drilling hole by the pressure difference between the two sides of the metering disc. The drilling holes are often bordered by special shapes, which are for example in relief and/or hollow, and arranged in the metering disc so as to guide and/or direct the seeds towards the drilling hole. These zones around the drilling holes are commonly known as stirrer elements.

Once the seeds have been distributed in the drilling holes of the metering disc, a system known as a selection system makes it possible to eliminate the excess seeds to avoid duplication, since several seeds may come to be contained in a single drilling hole, which is not desirable. The selection can be made using teeth, brushes or similar, that are fixedly mounted and are located outside and/or inside the path of the seeds. As a result, the excess seeds fall back into the reserve zone.

Once the seeds have been selected, they are transported to the last distribution zone, which is generally located in the last quarter turn of the metering disc, where there is no longer a pressure difference. This lack of a pressure difference causes the seed to exit the drilling hole and exit the metering unit towards the ground. The ejection of the seed can be assisted by a roller which makes it possible to cut the pressure difference and possibly push the seed out of the drilling hole by means of pegs.

After using the seed drill, it is common for a remainder of granular elements to be present in the reserve zone. Under certain conditions, the metering unit may require the granular elements still present in the reserve zone to be drained after use of the seed drill. This situation may arise, for example, when the door of the airtight casing needs to be opened in order to change the metering disc and/or to perform a cleaning and/or maintenance operation.

Usually, when the door is opened and/or when the disc is removed, depending on whether or not it is in the door, the remaining granular elements will fall to the ground outside of the metering unit.

This results in multiple problems, namely that the seeds on the ground need to be picked up and/or are spoiled, which is impractical and dirty.

To avoid the aforementioned problems and to facilitate draining, drain chutes are already known which are tilted towards the ground, but they only allow the remaining seeds to be poured into a container such as a bucket, bag or similar. This type of drain chute is therefore not optimal if the operator does not have a container available, and because the operator must be able to place it in the correct position before opening the door.

Draining can be performed with the door open or closed if the metering unit has a lower drain hatch at its outlet.

Existing drain chutes are generally added parts that can be attached to the metering unit when needed.

### Description of the Related Art

Document EP3610714A1 already describes a drain chute as described above. In particular, the drain chute can be mounted on both sides of the metering unit, allowing the metering unit to be drained from both sides.

### SUMMARY OF THE INVENTION

The present invention is intended to overcome at least one of the aforementioned drawbacks and aims to provide a solution allowing better preparation of the draining operation to improve draining.

To this end, the invention concerns a metering unit for a seed drill comprising at least:
an airtight casing comprising at least a fixed part and a door that can be moved between an open position and a closed position,
a metering element for a plurality of granular elements, arranged for discrete and singular distribution of a plurality of granular elements,
the metering element being placed inside the casing to separate the interior of the casing into a first chamber and a second chamber, which are different, the first chamber being configured to receive all or part of the plurality of granular elements at least in a reserve zone, and the second chamber being closed with the door in its closed position and being open with the door in its open position,
a drain chute mounted on the outside of the fixed part of the casing, preferably on the side of the second chamber, by at least one assembly element,
the metering unit is characterized in that the drain chute is configured so that it can be positioned in an intermediate drain position, in which the drain chute is configured to allow the flow of all or part of the plurality of granular elements initially present in the reserve zone towards a buffer zone of the drain chute and to allow the storage of said granular elements in the buffer zone without them flowing directly out of the drain chute, the buffer zone having a buffer height less than the reserve height.

The invention also relates to a seeder element comprising at least one hopper arranged to contain a plurality of granular elements and being connected by conveying means to said metering unit, characterized in that the metering unit is in accordance with the invention.

The invention also relates to a seed drill comprising at least one chassis on which at least one seeder element is mounted, characterized in that the at least one seeder element is in accordance with the invention.

The invention also relates to a drain method for a metering unit for a seed drill comprising a plurality of granular elements at least in the reserve zone, characterized in that the metering unit is in accordance with the invention and in that the method comprises at least:
a step to prepare for draining, during which the drain chute is positioned in an intermediate drain position, in which the drain chute allows the flow of all or part of the plurality of granular elements initially present in the reserve zone towards the buffer zone of the drain chute and allows the storage of said granular elements in the buffer zone without them flowing directly out of the drain chute, the buffer zone having a buffer height less than the reserve height.

### BRIEF DESCRIPTION OF THE DRAWINGS

The invention will be better understood through the following description, which refers to several preferred embodiments given as non-limiting examples and explained with reference to the attached schematic drawings, in which:

FIG. 1 shows a perspective view of a metering unit comprising a drain chute in an intermediate drain position according to the invention,

FIG. 2 shows a side view of the metering unit in FIG. 1,

FIG. 3 shows a perspective view of a metering unit comprising the drain chute in an outflow position according to a variant of the invention,

FIG. 4 shows a side view of the metering unit in FIG. 3,

FIG. 5 shows a perspective view of the metering unit comprising the drain chute in a folded position according to a variant of the invention,

FIG. 6 shows a perspective view of a metering unit without the drain chute,

FIG. 7 shows a perspective view of the drain chute illustrated in FIGS. 1 to 5 according to the invention,

FIG. 8 shows a perspective and bottom view of the drain chute illustrated in FIG. 7,

FIG. 9 shows a side view of the drain chute illustrated in FIG. 7, and

FIG. 10 shows a bottom view of the drain chute illustrated in FIG. 7.

### DETAILED DESCRIPTION OF THE PREFERRED EMBODIMENTS

A metering unit for a seed drill comprises at least:
an airtight casing 1 comprising at least a fixed part 2 and a door 3 that can be moved between an open position and a closed position,
a metering element for a plurality of granular elements, arranged for discrete and singular distribution of a plurality of granular elements,
the metering element being placed inside the casing 1 to separate the interior of the casing 1 into a first chamber 5 and a second chamber, which are different, the first chamber 5 being configured to receive all or part of the plurality of granular elements at least in a reserve zone 7, and the second chamber being closed with the door 3 in its closed position and being open with the door 3 in its open position,
a drain chute 8 mounted on the outside of the fixed part 2 of the casing 1, preferably on the side of the second chamber, by at least one assembly element 9.

According to the invention, the metering unit is characterized in that the drain chute 8 is configured so that it can be positioned in an intermediate drain position P1, in which the drain chute 8 is configured to allow the flow of all or part of the plurality of granular elements initially present in the reserve zone 7 towards a buffer zone 10 of the drain chute 8 and to allow the storage of said granular elements in the buffer zone 10 without them flowing directly out of the drain chute 8, the buffer zone 10 having a buffer height less than the reserve height.

Advantageously, in the intermediate drain position P1 of the drain chute 8, the chute is in a position in which the buffer zone 10 is designed so that the remaining granular elements, for example seeds coming from the reserve zone 7, flow away, without flowing directly out of the drain chute 8 and therefore downwards and potentially to the ground. In this intermediate drain position P1, the operator is for example able to carry out preparation operations before the draining operation, such as placing a container nearby or in the correct position before positioning the drain chute 8 in an outflow position P2 as described below. This configuration makes it possible to prepare the draining so that it can then be carried out under optimal conditions.

Preferably, at least in the intermediate drain position P1, the drain chute 8 is removably mounted to the fixed part 2 of the casing 1 by the at least one assembly element 9, preferably maneuverable with just one hand so as to be detachable from the fixed part 2 of the casing 1.

Advantageously, in this configuration it is possible to detach the drain chute 8 from the casing 1, then to pour the contents of the drain chute 8 into the hopper or into another container. The provision of a container for draining is therefore not necessary in this case. It is therefore also not necessary in this configuration to pass to the outflow position P2 described below to carry out the draining operation.

Preferably, the drain chute 8 can be positioned in an outflow position P2, configured to allow the flow to a discharge zone 11 of a lower discharge height relative to the buffer height, of all or part of the plurality of granular elements initially present in the reserve zone 7 or the buffer zone 10, the discharge zone 11 being located outside of the drain chute 8.

Advantageously, in this position, the drain chute 8 allows the flow of the granular elements initially contained in the reserve zone 7 or the buffer zone 10 towards the discharge zone 11 located below. A container may be placed at the discharge zone 11 to collect said granular elements.

Preferably, in the intermediate drain position P1, the drain chute 8 is horizontal or tilted by what is known as an intermediate angle of inclination, preventing the flow of granular element(s) out of the drain chute 8.

Preferably, in the outflow position P2, the drain chute 8 is tilted by what is known as a flow angle of inclination, allowing the flow of granular element(s), which is greater than the angle of inclination that is known as intermediate angle of inclination.

Advantageously, depending on the value of the angle of inclination, the drain chute 8 is either in the intermediate drain position P1 or in the outflow position P2. In the outflow position P2, the flow angle of inclination is greater than the angle of inclination known as intermediate angle of inclination in the intermediate drain position P1, since sufficient inclination is required to form a tilted plane allowing the granular elements to slide in the drain chute 8 towards the discharge zone 11 located below.

Preferably, the drain chute 8 comprises a first part 12 and a second part 14 comprising a second free end 15 of the drain chute 8, with the geometry of the second part 14 arranged to prevent the flow out of the drain chute 8 in the intermediate drain position P1.

Thanks to this configuration, the granular elements remain in the drain chute 8 in the buffer zone 10 in the intermediate drain position P1.

Preferably, the bottom 16 of the first part 12 of the drain chute 8 is flat and the bottom 16′ of the second part 14 is tilted upwards relative to the bottom 16 of the first part 12.

Advantageously, in the intermediate drain position P1, the granular elements are prevented from sliding downwards due to the existence in the second part 14 of the plane tilted upwards. This configuration also avoids overflow in the event of filling to the maximum level.

Preferably, the first end 13 of the drain chute 8 is configured so as to be mounted on the fixed part 2 of the casing 1 by the at least one assembly element 9, which can preferably be maneuvered with just one hand.

Advantageously, the drain chute 8 can be mounted on or dismounted from the fixed part 2 by the assembly element 9. The drain chute 8 is therefore fully dismountable and can be detached either after draining in the intermediate drain position P1, or with a view to its storage. In the first case, it is possible to take the drain chute 8 manually, for example, and drain its contents at the required location. In the second case, the drain chute 8 is dismounted and stored outside of the metering unit when not in use. For example, it is possible to attach it to another component of the seeder element, such as on one of the hopper walls, inside the hopper cover or even on the seeder element chassis.

If the assembly element 9 can be maneuvered with just one hand, this is more ergonomic since the operator can use one hand to unhook the drain chute 8 and the other hand to hold a container or open the hopper to discharge the granular elements therein.

Preferably, the second part 14 has a transverse cross-section narrowing towards the second end 15.

Advantageously, the second part 14 tightens in the direction of the second free end 15 to facilitate the guidance and flow of the granular elements towards the discharge zone 11, and possibly towards a container such as a bag or a bucket located in this discharge zone 11.

Preferably, the drain chute 8 can be positioned in a folded position P3, in which it is configured to be placed folded against the door 3 in its closed position.

Advantageously, in this alternative configuration to dismounting, the drain chute 8 is folded against the movable door 3 when not in use. This avoids the need to dismount the drain chute 8 for storage. The drain chute 8 is stored on the metering unit.

Preferably, the drain chute 8 is mounted so as to be mobile, preferably in rotation by the at least one assembly element 9, which can preferably be maneuvered with just one hand, to be positioned in the intermediate drain position P1, in the outflow position P2, and between said positions, without requiring the drain chute 8 to be detached from the fixed part 2 of the casing 1.

Preferably, the drain chute 8 is mounted so as to be mobile, preferably in rotation by the at least one assembly element 9, which can preferably be maneuvered with just one hand, to be positioned in the intermediate drain position P1, in the outflow position P2 and in a folded position P3, and between said positions, without requiring the drain chute 8 to be detached from the fixed part 2 of the casing 1.

Advantageously, in these configurations, the drain chute 8 pivots relative to the fixed part 2 to pass into the different positions without requiring the drain chute 8 to be detached from the fixed part 2 of the casing 1 to pass from one position to the other.

The casing 1 comprises the fixed part 2 and the door 3 which can be moved relative to the fixed part 2 and allows the casing 1 to be opened or closed.

The metering element that is not shown preferably usually comprises a drilled metering disc driven in rotation, preferably by a motor. The metering disc separates the casing into two chambers, the first chamber 5 and the second chamber, in which the air pressures are different.

The reserve zone 7 is located in the first chamber 5. It can contain a certain quantity of granular elements originating from the hopper which must be drained, and can be drained using the drain chute 8. The reserve zone 7 is located at the bottom of the fixed part 2 of the casing 1.

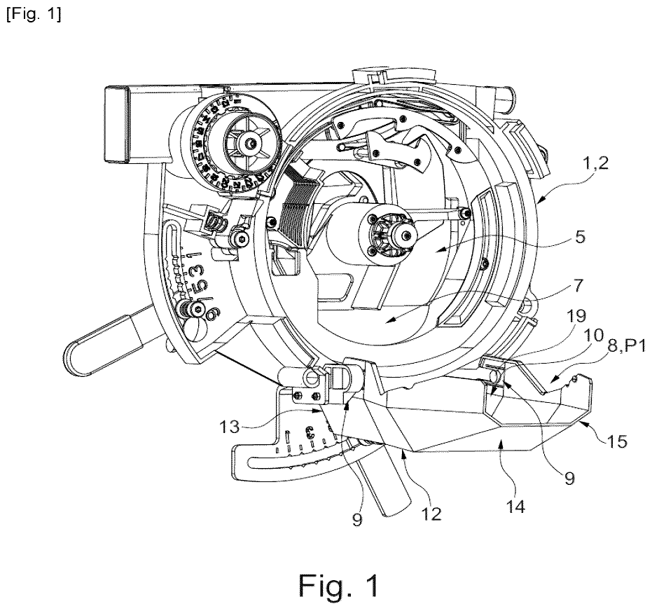

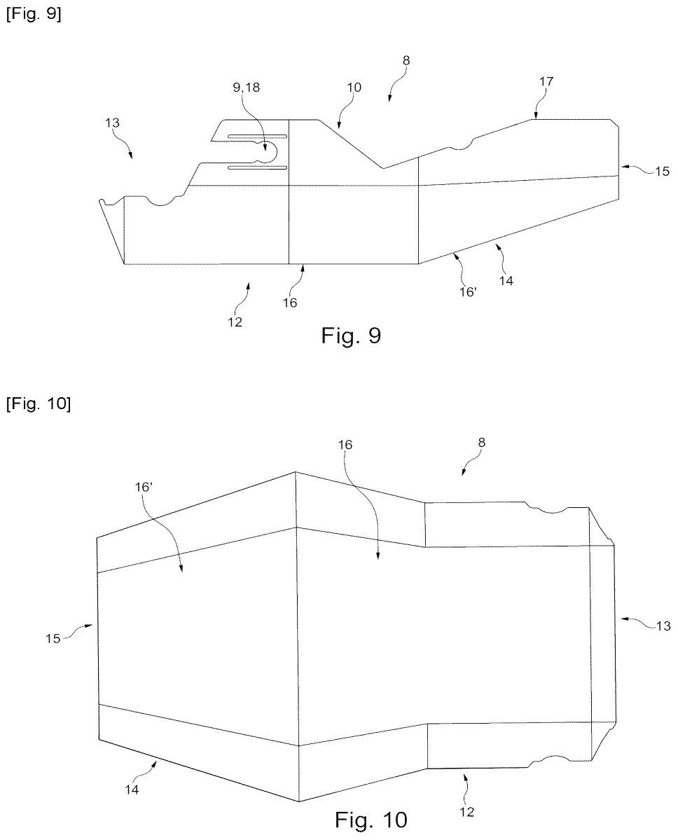

The drain chute 8 may take the form of an open duct, for example in the form of a gutter, as shown in FIGS. 1 to 5 and 7 to 10.

The drain chute 8 preferably comprises two side walls 17 joined by the bottom 16, 16′, and has a substantially U-shaped cross-section.

The drain chute 8 is mounted on the casing 1 at the fixed part 2. It preferably consists of a removable added part, which can be dismounted using one or more assembly elements 9.

The function of the assembly element(s) 9 is to enable the drain chute 8 to be fastened to the fixed part 2. Furthermore, this or these assembly element(s) 9 can allow reversible mounting and dismounting of the drain chute 8, so that it can be detached from the fixed part 2. Furthermore, this or these assembly element(s) 9 can also allow rotation of the drain chute 8 with respect to the fixed part 2 in and between said positions P1, P2, P3. This or these assembly element(s) 9 are preferably placed on the fixed part 2 on the one hand and on the drain chute 8 on the other hand.

The assembly element(s) 9 may comprise a pair of pins 19 mounted on the fixed part 2 by fastening means 20 and a pair of slots or openings or sliding rails 18 located at the first end 13 in which the pair of pins 19 engages when the drain chute 8 is mounted on the fixed part 2.

Preferably, the pair of slots or openings or sliding rails 18 is arranged on the side walls 17 at the first end 13. The sliding rails 18 make it possible to easily mount/dismount the drain chute 8.

The buffer zone 10 is preferably located inside the drain chute 8 in the intermediate drain position P1. Its function is to allow the storage of the granular elements in the intermediate drain position P1.

The discharge zone 11 is located outside of the drain chute 8. The discharge zone 11 is below the buffer zone 10. The discharge zone 11 may be at ground level or in a container such as for example a bag, bucket, etc.

The second end 15 of the drain chute 8 is open and forms an outlet 21 from which granular elements can flow, unlike the first end 13 which is closed by a wall 22 that laterally connects the two side walls 17.

The drain chute 8 is dimensioned so that the maximum volume of granular elements of a metering unit can approximately be stored in the drain chute 8 in the intermediate drain position P1.

The drain chute 8 may comprise a bend (not shown) for directing the second end 15 towards the front or towards the rear depending on the orientation of the metering unit.

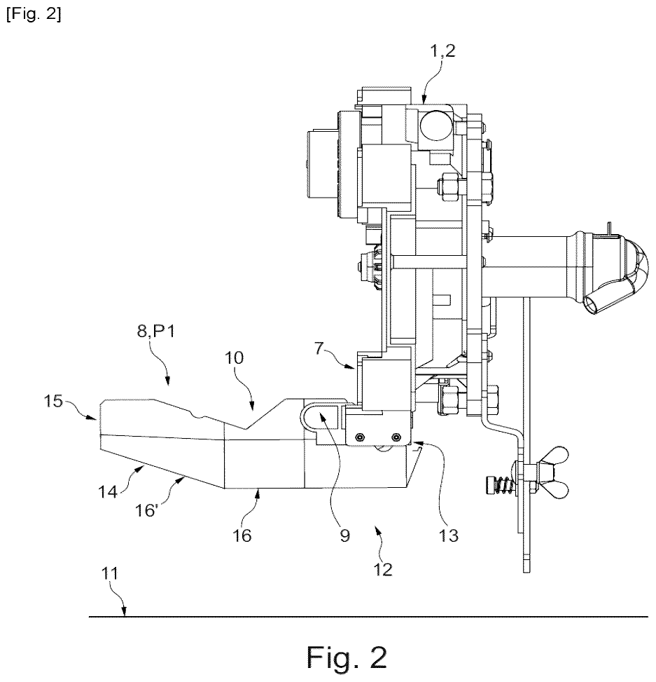

FIGS. 1 and 2 show the metering unit comprising the drain chute 8 in the intermediate drain position P1. The casing 1 is without the door 3. In the fixed part 2 of the casing 1, the first chamber 5 may contain in the reserve zone 7 all or part of the plurality of granular elements, which are not shown. The drain chute 8 is placed under the reserve zone 7 and can collect the granular elements coming from the reserve zone 7 in the buffer zone 10. These granular elements are stored in the buffer zone 10 without flowing directly out of the drain chute 8. In this example, the drain chute 8 is horizontal in the intermediate drain position P1, which prevents the flow of granular elements towards the discharge zone 11 which is located below. In fact, the bottom 16 of the first part 12 is horizontal and the bottom 16′ of the second part 14 is tilted upwards.

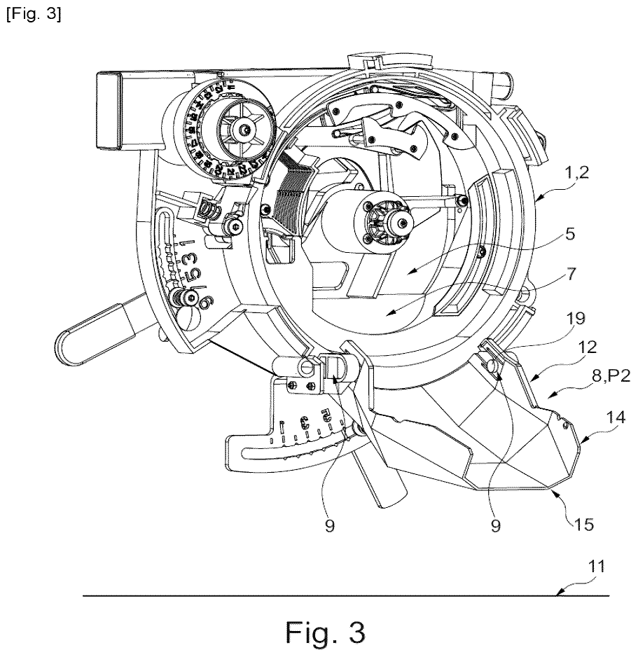

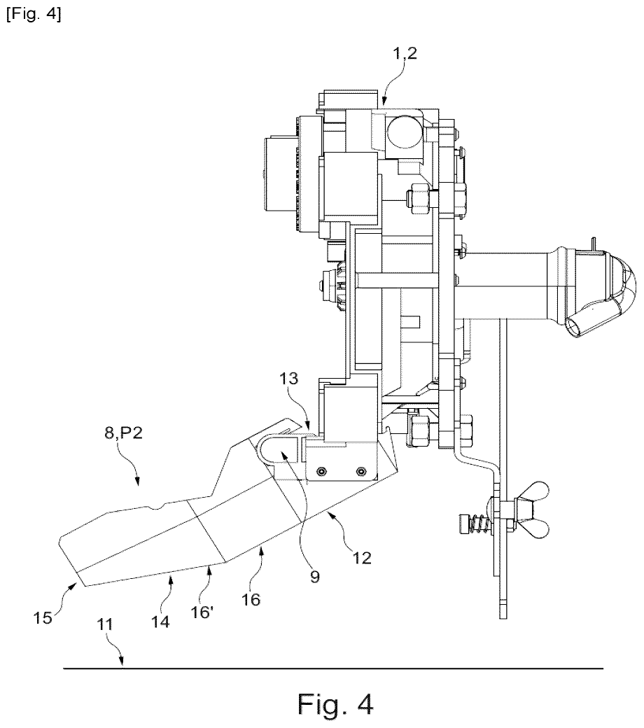

FIGS. 3 and 4 show the metering unit comprising the drain chute 8 in the outflow position P2. In this example, the drain chute 8 is tilted towards the discharge zone 11 in the outflow position P2 which allows the flow of granular elements towards the discharge zone 11. In fact, the bottom 16 of the first part 12 and the bottom 16′ of the second part are tilted downwards. The second free end 15 is oriented downwards.

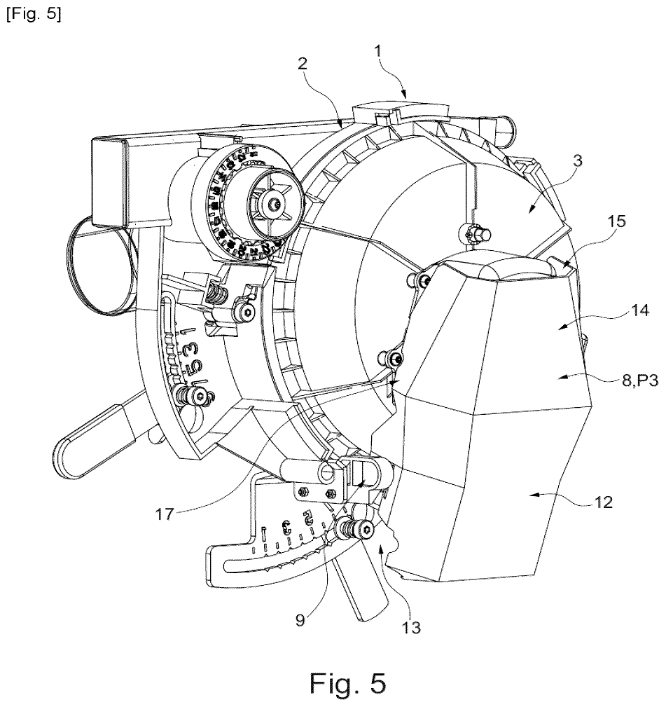

FIG. 5 shows the metering unit comprising the drain chute 8 in the folded position P3. In this example, the casing 1 comprises the fixed part 2 closed by the door 3. The drain chute 8 is placed against the door 3. The second free end 15 is oriented upwards. The side walls 17 are opposite the door 3.

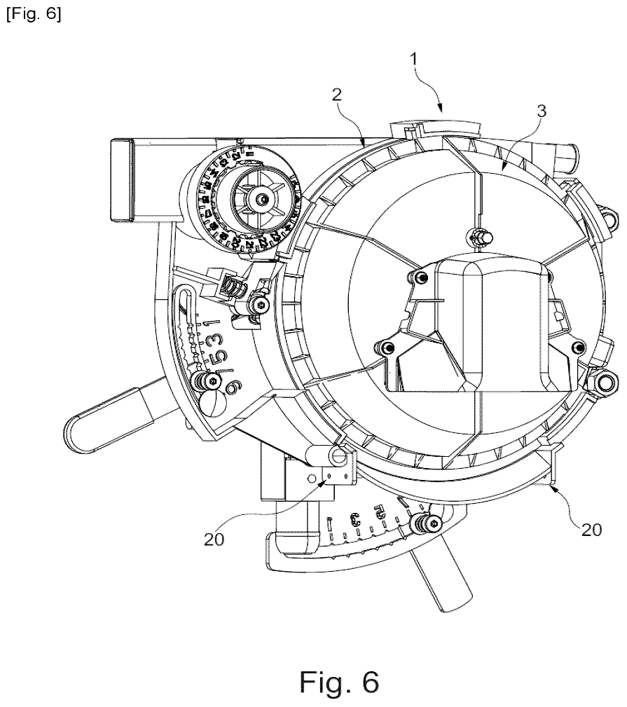

FIG. 6 shows the metering unit without the drain chute 8. In this example, the casing 1 comprises the fixed part 2 closed by the door 3. The fixed part 2 comprises the fastening means 20 allowing a pair of pins 19 to be mounted. The fastening means 20 take the form of two plates projecting from the fixed part 2 in a lower part located beneath the reserve zone 7, which is not visible.

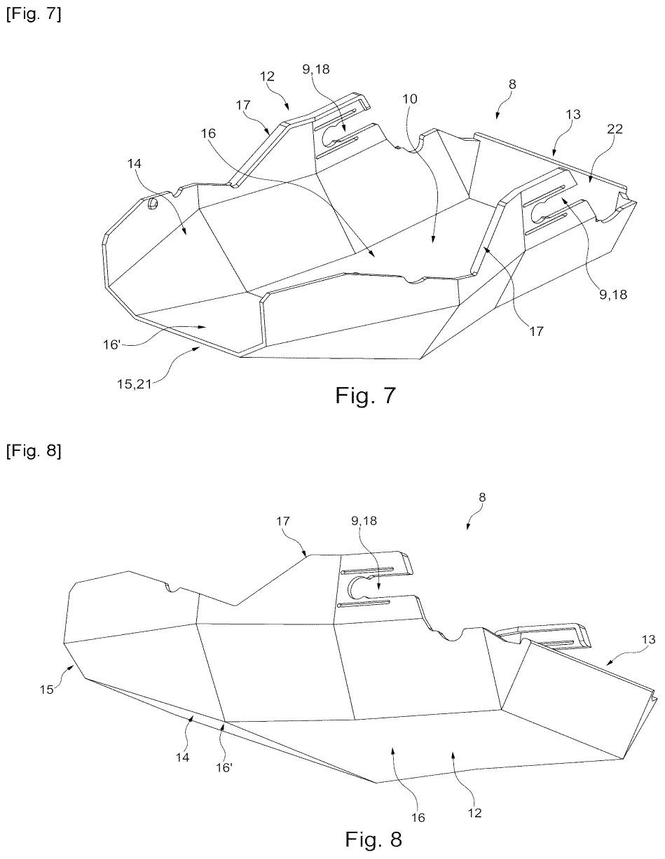

FIGS. 7 to 10 illustrate the drain chute 8 illustrated in FIGS. 1 to 5 according to the invention. The drain chute 8 is an added part and separate from the casing 1. In this example, the drain chute 8 comprises the first part 12 comprising the first end 13 and the second part 14 comprising the second end 15. The drain chute 8 comprises two side walls 17 joined by the bottom 16, 16′, and has a substantially U-shaped cross-section. The first end 13 is closed by the wall 22, which laterally connects the two side walls 17. Furthermore, the bottom 16 of the first part 12 of the drain chute 8 is flat and the bottom 16′ of the second part 14 is tilted upwards relative to the bottom 16 of the first part 12. The first part 12 has a transverse cross-section widening towards the second part 14. The second part 14 has a transverse cross-section narrowing towards the second end 15. A pair of sliding rails 18 is provided on the side walls 17 at the first end 13. The second end 15 of the drain chute 8 is open and forms the outlet 21.

The invention also relates to a seeder element, not shown, comprising at least one hopper arranged to contain a plurality of granular elements and being connected by conveying means to said metering unit, characterized in that the metering unit is in accordance with the described invention.

The invention also relates to a seed drill, not shown, comprising at least one chassis on which at least one seeder element is mounted, characterized in that the at least one seeder element is in accordance with the described invention.

The invention also relates to a drain method for a metering unit for a seed drill comprising a plurality of granular elements at least in the reserve zone 7, characterized in that the metering unit is in accordance with the invention and in that the method comprises at least:
a step to prepare for draining, during which the drain chute 8 is positioned in an intermediate drain position P1, in which the drain chute 8 allows the flow of all or part of the plurality of granular elements initially present in the reserve zone 7 towards the buffer zone 10 of the drain chute 8 and allows the storage of said granular elements in the buffer zone 10 without them flowing directly out of the drain chute 8, the buffer zone 10 having a buffer height less than the reserve height.

Advantageously, thanks to the method according to the invention, during the step of preparing for draining, the granular elements are stored in the buffer zone 10 without them flowing directly out of the drain chute 8 and therefore downwards and potentially to the ground. The draining step can then take place under optimal conditions.

In fact, during the draining step, the drain chute 8 is then either detached so as to drain the contents into a container or into the hopper, or the drain chute 8 is positioned in the outflow position P2 and the granular elements initially contained in the reserve zone 7 or the buffer zone 10 flow towards the discharge zone 11 located below.

Obviously, the invention is not limited to the embodiments described and shown in the attached drawings. Modifications remain possible, in particular as regards the composition of the various elements or the substitution by technical equivalents without departing from the scope of protection of the invention.

1. A metering unit for a seed drill comprising at least:
an airtight casing comprising at least a fixed part and a door that can be moved between an open position and a closed position,
a metering element for a plurality of granular elements, arranged for discrete and singular distribution of a plurality of granular elements, the metering element being placed inside the casing to separate the interior of the casing into a first chamber and a second chamber, which are different, the first chamber being configured to receive all or part of the plurality of granular elements at least in a reserve zone, and the second chamber being closed with the door in its closed position and being open with the door in its open position,
a drain chute mounted on the outside of the fixed part of the casing, preferably on the side of the second chamber, by at least one assembly element, the metering unit is characterized in that the drain chute is configured so that it can be positioned in an intermediate drain position, in which the drain chute is configured to allow the flow of all or part of the plurality of granular elements initially present in the reserve zone towards a buffer zone of the drain chute and to allow the storage of said granular elements in the buffer zone without them flowing directly out of the drain chute, the buffer zone having a buffer height less than the reserve height.

2. The metering unit according to claim 1, wherein at least in the intermediate drain position, the drain chute is removably mounted from the fixed part of the casing by the at least one assembly element, preferably maneuverable with just one hand so as to be detachable from the fixed part of the casing.

3. The metering unit according to claim 1, wherein the drain chute can be positioned in an outflow position, configured to allow the flow, towards a discharge zone of a lower discharge height relative to the buffer height, of all or part of the plurality of granular elements initially present in the reserve zone or the buffer zone, the discharge zone being located outside of the drain chute.

4. The metering unit according to claim 1, wherein in the intermediate drain position, the drain chute is horizontal or tilted by what is known as an intermediate angle of inclination, preventing the flow of granular element(s) out of the drain chute.

5. The metering unit according to claim 3, wherein in the outflow position, the drain chute is tilted by what is known as a flow angle of inclination, allowing the flow of granular element(s), which is greater than the angle of inclination known as intermediate angle of inclination.

6. The metering unit according to claim 1, wherein the drain chute comprises a first part and a second part comprising a second free end of the drain chute, with the geometry of the second part arranged to prevent the flow out of the drain chute in the intermediate drain position.

7. The metering unit according to claim 6, wherein the bottom of the first part of the drain chute is flat and the bottom of the second part is tilted upwards relative to the bottom of the first part.

8. The metering unit according to claim 6, wherein the second part has a transverse cross-section narrowing towards the second end.

9. The metering unit according to claim 3, wherein the drain chute is mounted so as to be mobile, preferably in rotation by the at least one assembly element, which can preferably be maneuvered with just one hand, to be positioned in the intermediate drain position, in the outflow position, and between said positions, without requiring the drain chute to be detached from the fixed part of the casing.

10. A seeder element comprising at least one hopper arranged to contain a plurality of granular elements and being connected by conveying means to said metering unit, wherein the metering unit is in accordance with claim 1.

11. A seed drill comprising at least one chassis on which at least one seeder element is mounted, wherein the at least one seeder element is in accordance with claim 10.

12. A drain method for a metering unit for a seed drill comprising a plurality of granular elements at least in the reserve zone, wherein the metering unit is in accordance with claim 1, and in the method comprises at least:
a step to prepare for draining, during which the drain chute is positioned in an intermediate drain position, in which the drain chute allows the flow of all or part of the plurality of granular elements initially present in the reserve zone towards the buffer zone of the drain chute and allows the storage of said granular elements in the buffer zone without them flowing directly out of the drain chute, the buffer zone having a buffer height less than the reserve height.
